(19) United States
(12) Patent Application Publication
(10) Pub. No.: US 2022/0096332 A1
(43) Pub. Date: Mar. 31, 2022

(54) ANTI-REFLUX NASOGASTRIC TUBE

(71) Applicant: MocaCare, Corp, Redwood City, CA (US)

(72) Inventors: Wei-Chen Hong, Taipei City 104 (TW); Hang-Yi Lin, Taipei City 104 (TW); Hsin-Hui Huang, Taipei City 104 (TW)

(21) Appl. No.: 17/033,404

(22) Filed: Sep. 25, 2020

(51) Int. Cl. A61J 15/00

(52) U.S. Cl. CPC A61J 15/0003; A61J 15/0092

(57) ABSTRACT

An anti-reflux nasogastric tube includes a tube body and a positioning sleeve. The tube body has a first end and a second end. The first end has an opening. The second end has at least one hole. The opening communicates with the at least one hole through a pipeline. The positioning sleeve is disposed at the opening and has a socket part and an outer edge. The outer edge is located at one end of the socket part. The outer diameter of the outer edge is larger than the inner diameter of the nostril of the human body. Thus, the present invention allows the anti-reflux joints to be stuck in the nasal cavity of the human body by the structure of the positioning sleeve, and does not need to adhere the tube body to the cheek of the human body by adhering, thereby reducing the patient's discomfort and increasing the aesthetic appearance and avoiding inadvertent pulling.

### BACKGROUND OF THE INVENTION

### 1. Field of the Invention

The invention relates to a nasogastric tube, in particular to an anti-reflux nasogastric tube discreetly disposed in the nasal cavity of a human body, thereby reducing the patient's discomfort and increasing the aesthetic appearance and avoiding inadvertent pulling.

### 2. Background

A nasogastric tube is a soft, flexible hose placed in the stomach through the nasal cavity and esophagus so that the patient can be fed smoothly from the nasal cavity. The nasogastric tube is used to transport liquid food, thereby reducing the burden of esophagus. A nasogastric tube may be used, for example, to facilitate healing of the throat and esophagus after surgery.

FIG. 1 is a schematic view of a conventional nasogastric tube 80 in use. As shown in FIG. 1, the conventional nasogastric tube 80 includes a hollow tube body 81 having proximal and distal ends with a joint 82 provided at the proximal end. The distal end of tube 80 is placed in the stomach through the nasal cavity and the esophagus. The joint 82 has an opening 821 fluidically coupled with a lumen of the hollow tube body 81. Opening 821 may be coupled with a feeding needle (not shown) or a feeding container (not shown). The liquid food can sequentially pass through a feeding needle or a feeding container, the joint 82 of the nasogastric tube 80 and tube body 81 to flow into the tube body to enter the stomach of the human body.

The proximal end extends from the nasal opening, and is typically taped to the cheek of the patient. Taping the nasogastric tube to the patient's cheek may cause patient discomfort, and the exposed nasogastric tube 80 taped to the patient's cheek is unsightly. Furthermore, since the tube body 81 is long the patient may inadvertently dislodge the nasogastric tube by pulling on the proximal end.

In addition, the conventional joint 82 further has a cover plug 83 that can cover the opening 821 of the joint 82 to prevent the nasogastric tube 80 from being contaminated by the environment as well as to prevent regurgitation of the food remaining in the tube body 81. However, the joint 82 has to be manually closed by the cover plug 83. Once the cover plug 83 is disengaged from the opening 821, the cover plug 83 still may be detached, which is inconvenient to use and loses its original function.

FIG. 2 is a schematic view of a conventional right-angle nasogastric tube 84 in use. As shown in FIG. 2, the conventional right-angle nasogastric tube 84 includes a tube body 81 and a right angle joint 85. The proximal end of the tube body 81 is connected to the right angle joint 85, and the other (distal) end is placed in the stomach through the human nasal cavity and the esophagus. The right angle joint 85 has a first channel 851 and a second channel 852. The first passage 851 and the second passage 852 communicate with each other, and the axes of the first passage 851 and the second passage 852 are mutually perpendicular.

The structure of the right-angle nasogastric tube 84 is incapable of avoiding the disadvantages of the aforementioned first kind of the conventional nasogastric tube. Moreover, the right angle joint 85 is more likely to retain liquid food and is difficult to clean.

What is needed is an improved nasogastric feeding tube which is less susceptible to being dislodged or removed by the patient and which more discreet.

### SUMMARY OF THE INVENTION

Disclosed herein is an anti-reflux nasogastric tube which is placed in the nasal cavity of a human body and which does not need to be taped to the cheek of the human body, thereby reducing patient's discomfort and increasing aesthetic appearance and avoiding inadvertent dislodgment.

The examples disclosed herein include an anti-reflux joint (normally-closed valve) to prevent the food from flowing (regurgitating) back from the nasogastric tube when the patient is being fed.

Example 1: An anti-reflux nasogastric tube sized for insertion into a nostril of the human body, comprising: a tube body having a sidewall and a lumen extending between a proximal end and a distal end thereof, the proximal end having an opening, at least one through-hole defined in the sidewall proximal the distal end, the opening is in fluid communication with the at least one through-hole; and a positioning sleeve mounted to the tube body and in fluid communication with the opening, the positioning sleeve having a socket part and an outer edge, the outer edge located at one end of the socket part, the outer edge having a diameter selected to be larger than an inner diameter of the nostril of the human body.

Example 2: The anti-reflux nasogastric tube of Example 1, further comprising an anti-reflux joint disposed on a first end of the tube body and located in the socket part, the anti-reflux joint comprising a housing and an anti-reflux element, the housing having a channel, and one end of the housing is provided with a linking part for connecting an extracorporeal tube, the anti-reflux element is disposed in communication with the channel.

Example 3: The anti-reflux nasogastric tube of Example 2, wherein the channel has a first through-hole, a second through-hole and a storage space interposed therebetween, the storage space is in communication between the first through-hole and the second through-hole for communicating with the extracorporeal tube.

Example 4: The anti-reflux nasogastric tube of Example 3, wherein the anti-reflux element comprises a shaft part and a biasing element, the shaft part has a first end, a second end, a propping part and a collar, the first end of the shaft part extends in the first through-hole, the propping part is disposed on the first end of the shaft part and has at least one piercing hole, the collar is disposed between the first end and the second end of the shaft part and located in the storage space, the outer diameter of the convex ring in an unstressed state is larger than the inner diameter of the first through-hole in an unstressed state, the outer diameter of the convex ring in an unstressed state is smaller than the inner diameter of the storage space, the biasing element is sleeved on the second end of the shaft part, one end of the biasing element abuts the collar, the other end abuts a bottom wall of the storage space.

Example 5: The anti-reflux nasogastric tube of Example 4, wherein the anti-reflux element further comprises a sealing ring, the sealing ring is disposed on a side of the convex ring adjacent to the first end of the shaft portion, the outer diameter of the sealing ring in an unstressed state is larger than the inner diameter of the first through-hole, and the inner diameter of the sealing ring in an unstressed state is smaller than the outer diameter of the collar ring in an unstressed state.

Example 6: The anti-reflux nasogastric tube of Example 4, wherein the outer diameter of the biasing element is larger than the inner diameter of the second through-hole.

Example 7: The anti-reflux nasogastric tube of Example 3, wherein the anti-reflux element has a sealing part, a penetrating hole and a blocking part, the sealing part is located in the storage space, the penetrating hole penetrates through the sealing part, the blocking part is disposed at one end of the sealing part and located in the first through-hole, at least one slit is provided at the top of the blocking part.

Example 8: The anti-reflux nasogastric tube of Example 7, wherein the housing further comprises a bottom housing having a threaded portion and an extending tube, the extending tube has a second through-hole.

Example 9: The anti-reflux nasogastric tube of Example 2, wherein the housing further comprises a positioning part, the positioning part is convexly disposed at a middle portion of the housing, the outer diameter of the positioning part in an unstressed state is larger than the inner diameter of the sleeve part in an unstressed state, so that the socket part is expanded outwardly by the positioning part to be positioned on the housing.

Example 10: The anti-reflux nasogastric tube of Example 1, further comprising a pillar plug, the outer diameter of the plug in an unstressed state is greater than the inner diameter of the positioning sleeve in an unstressed state.

Example 11: The anti-reflux nasogastric tube of Example 2, wherein the anti-reflux joint is a normally-closed valve.

Example 12: The anti-reflux nasogastric tube of Example 1, wherein the positioning sleeve has a proximal end and a distal end, a diameter of the distal end is selected to be smaller than the inner diameter of the nostril such that the distal end is received within the nostril.

Example 13: A nasogastric tube assembly, comprising: a proximal connector having a proximal end and a distal end, the proximal end configured for attachment to a feeding tube, the connector having a lumen extending between the proximal and distal ends; a nose attachment member attached to an exterior surface of the connector; and a normally-closed valve in fluid communication with the proximal connector lumen.

Example 14: The nasogastric tube assembly of Example 13, further comprising: a distal connector having a proximal end and a distal end; a lumen extending between the proximal and distal ends; the distal connector proximal end removably connected to the distal end of the proximal connector such that the distal connector lumen is in fluid communication with the proximal connector lumen; and a projection on the proximal end of the distal connector; wherein the projection opens the normally-closed valve when the distal connector is engaged with the proximal connector.

Example 15: The nasogastric tube assembly of Example 13, wherein the nose attachment member is formed of an elastomeric material.

Example 16: The nasogastric tube assembly of Example 14, wherein the distal end of the distal connector includes a mounting portion configured for attachment to a tube.

Example 17: The nasogastric tube assembly of Example 14, wherein the projection is a tubular projection in fluid connection with the distal connector lumen.

### BRIEF DESCRIPTION OF THE DRAWINGS

FIG. 1 is a schematic view of a conventional nasogastric tube in use;

FIG. 2 is a schematic view of a conventional right-angle nasogastric tube in use;

FIG. 3 is a perspective view of an anti-reflux nasogastric tube of the present invention;

FIG. 4 is an exploded perspective view of the anti-reflux nasogastric tube of FIG. 3;

FIGS. 5A-5B are a cross sectional views of the anti-reflux nasogastric tube of FIG. 3;

FIG. 6 is a using schematic view of the anti-reflux nasogastric tube of FIG. 3 connected with the extracorporeal tube;

FIG. 7 is a schematic view of the anti-reflux nasogastric tube used in the human body;

FIG. 8 is a perspective view of the anti-reflux nasogastric tube according to a second example;

FIG. 9A is a front view of the anti-reflux nasogastric tube of FIG. 8;

FIG. 9B is a cross sectional view of the anti-reflux nasogastric tube of the FIG. 8;

FIG. 9C is a partially exploded cross sectional view of the anti-reflux nasogastric tube of the FIG. 8;

FIG. 10A is a front view of the anti-reflux nasogastric tube of FIG. 8 connected with the outer pipe joint;

FIG. 10B is a cross-sectional view of the anti-reflux nasogastric tube of FIG. 8 connected with the outer pipe joint;

FIG. 11A is a front view of after the anti-reflux nasogastric tube of FIG. 8 connected with the outer pipe joint;

FIG. 11B is a cross-sectional view of after the anti-reflux nasogastric tube of FIG. 8 connected with the outer pipe joint;

FIG. 12 is a perspective view of another example anti-reflux nasogastric tube of the present invention;

FIGS. 13 and 14 show a fully assembled and partially disassembled nasal feeding assembly;

FIG. 15 is a view of connector 134 of FIG. 13;

FIG. 16 is a view of connector 133 of FIG. 13; and

FIG. 17 shows the nasal feeding assembly of FIG. 13 in use on a nostril.

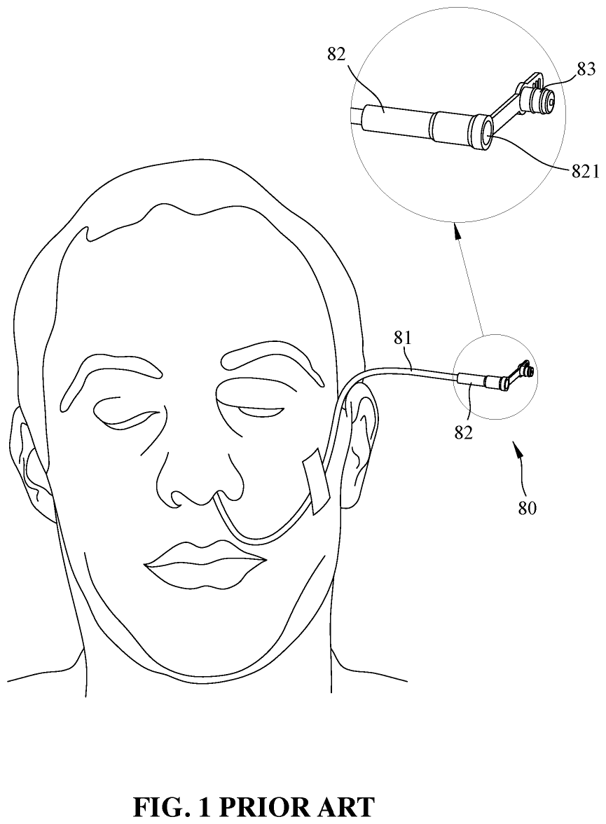

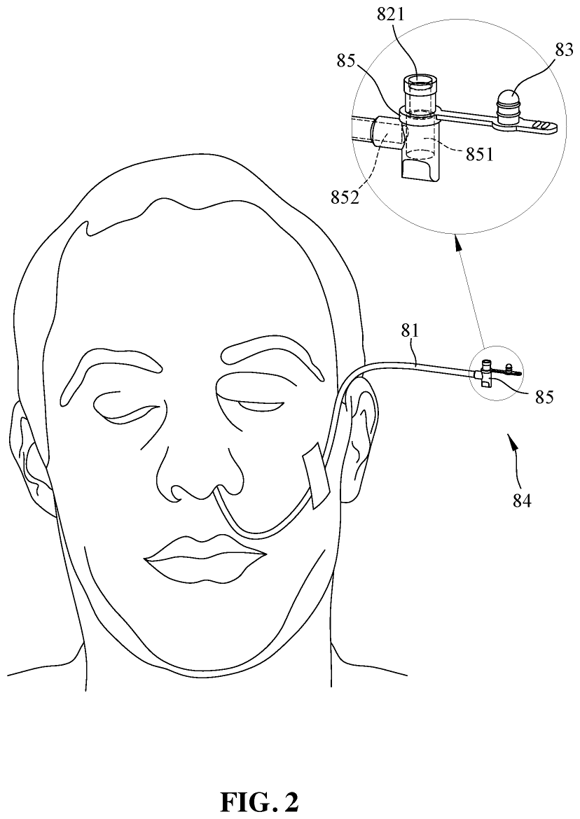

### DETAILED DESCRIPTION OF THE PREFERRED EMBODIMENT

The description of the present invention will be described in more detail below with reference to the drawings and the reference numerals, those skilled in the art can implement after studying this specification.

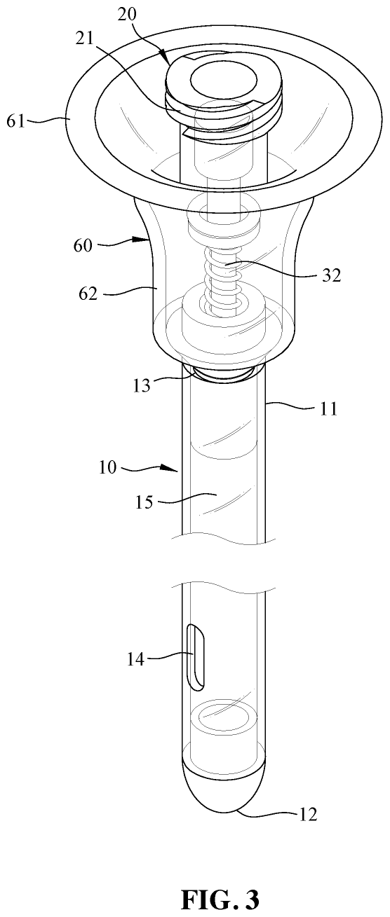

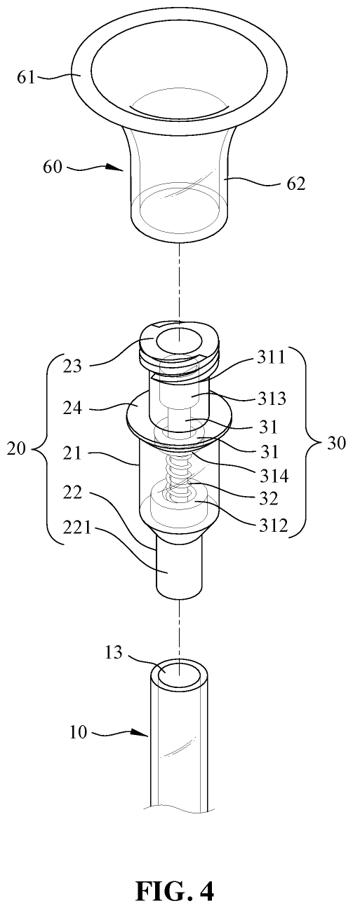

FIGS. 3 and 4 are respectively a perspective view and an exploded perspective view of the anti-reflux nasogastric tube of a first example. As shown in FIGS. 3 and 4, the present invention provides an anti-reflux nasogastric tube comprising a tube body 10 and a positioning sleeve 60. The following is a detailed explanation of each part.

The tube body 10 has a first (proximal) end 11, a second (distal) end 12, and a lumen 15 extending therebetween. The proximal (first) end 11 has an opening 13. A through-hole 14 is defined through the sidewall of the tube body, providing fluid communication through the sidewall. In some examples, the distal end of the tube body 11 has a closed end. In other examples, the distal end of the tube body 10 has an opening in fluid communication with the opening 13. In the drawings the through-hole 14 is depicted as being proximal the distal end 12. The opening 13 communicates with the hole 14 through a lumen 15. The tube body 10 may be formed from a flexible plastic or silicone material soft hose, which prevents the tube body 10 from injuring the surface tissues of the nasal cavity and the esophagus during placement in the stomach through the nasal cavity and the esophagus. The drawings depict a single through-hole 14; however, two or more through-holes 14 may be provided and fall within the scope of the invention.

As best seen in FIG. 3, the positioning sleeve 60 is disposed at the opening 13 and has a socket part 62 and an outer edge 61. The outer edge 61 is located at a first (proximal) end of the socket part 62. Preferably, the outer diameter of the outer edge 61 is larger than the maximum inner diameter of the nostril of the human body, so that the positioning sleeve 60 can be stuck in the nostril of the human body. The distal end of the positioning sleeve 60 has an outer diameter which is smaller than both the outer diameter of the outer edge 61. In some examples, the outer diameter of the distal end of the positioning sleeve is smaller than the minimum inner diameter of the nostril of the human body. This enables the distal end of the positioning sleeve to comfortably and discreetly reside within the nostril. The positioning sleeve may have a frustoconical shape whose diameter is narrowest at the distal end and widest at outer edge 61.

In a first example of the present invention, the anti-reflux nasogastric tube further includes an anti-reflux joint 20 disposed at the first end 11 of the tube body 10 and located in the socket part 62. The anti-reflux joint 20 includes a housing 21 and an anti-reflux element 30 (normally-closed check valve).

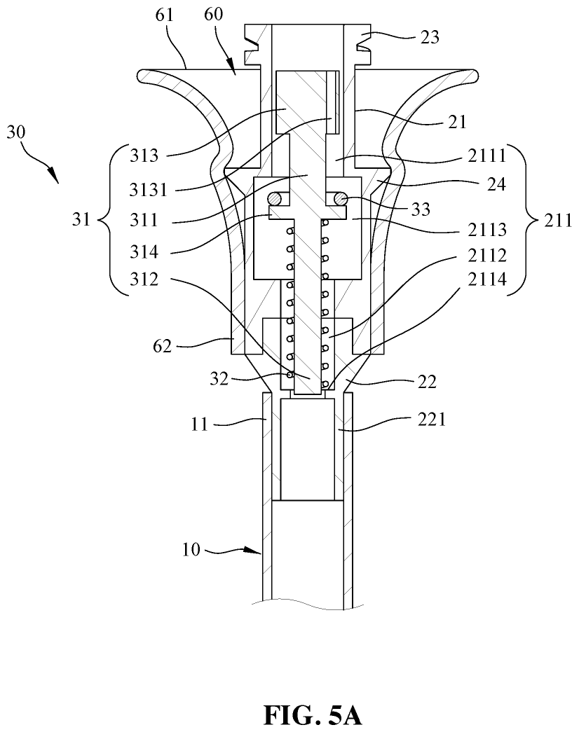

FIGS. 5A-5B are a cross-sectional views of the anti-reflux nasogastric tube of FIG. 3. As shown in FIGS. 5A-5B, the housing 21 has a channel 211. The channel 211 has a first through-hole 2111, a second through-hole 2112, and storage space 2113. The storage space 2113 is communicated between the first through-hole 2111 and the second through-hole 2112. The anti-reflux element 30 is disposed in the channel 211.

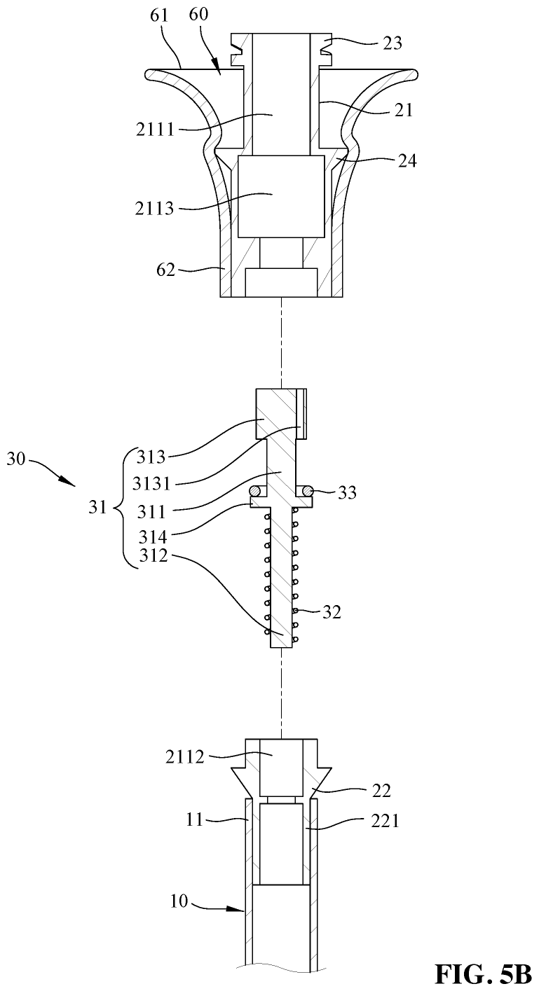

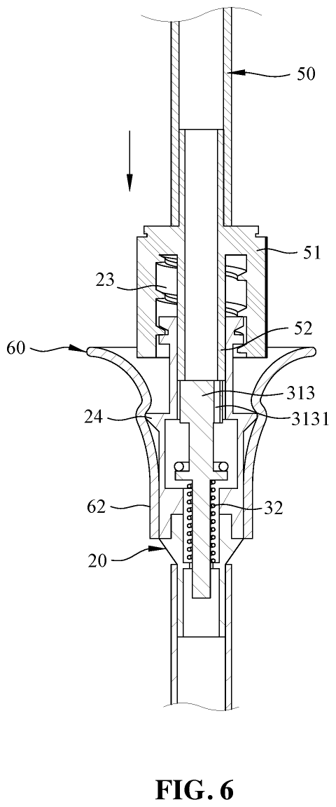

Preferably, a first (proximal) end of the housing 21 is provided with a linking part 23 for removably connecting an extracorporeal tube 50 (shown in FIGS. 6 and 7). The linking part 23 may, for example, be an external thread (or an internal thread), and one end of the housing 21 is screwed to one of the outer pipe joints 51 (shown in FIGS. 6 and 7) of the extracorporeal tube 50 (shown in FIGS. 6 and 7) to communicate the first through-hole 2111 with the extracorporeal tube 50 (shown in FIGS. 6 and 7). Any number of quick-connect mechanisms may be used to connect the extracorporeal tube 50 to the housing 21. The invention is not limited to a linking part 23 having either an internal or external thread.

Preferably, the outer edge 61 of the positioning sleeve 60 is located at one end of the socket part 62 and has one end of the linking part 23 adjacent to the housing 21.

In the first example of the present invention, the housing 21 further includes a bottom housing 22. The bottom housing 22 has an extending tube 221. The extending tube 221 has a second through-hole 2112 defined in the sidewall of the extending tube. The first end 11 of the tube body 10 can be sleeved on the extending tube 221 of the bottom housing 22 to communicate the second through-hole 2112 with the tube body 10.

In the first example of the present invention, the housing 21 further includes a positioning part 24, the positioning part 24 is convexly disposed at a middle portion of the housing 21. The outer diameter of the positioning part 24 is larger than the inner diameter of the socket part 62 (interference fit), so that the socket part 62 is expanded outwardly by the positioning part 24 to be positioned on the housing 21. Thereby, achieve the effect of positioning of the positioning sleeve 60 and the prevention of falling off.

In the first embodiment of the present invention, the anti-reflux element 30 includes a shaft part 31 and a biasing element such as a spring 32, elastomeric member or the like; the shaft part 31 has a first (proximal) end 311, a second (distal) end 312, a propping part 313 and a collar 314; the first end 311 of the shaft part 31 extends or is partially house within the first through-hole 2111. The propping part 313 is disposed on the first (proximal) end 311 of the shaft part 31 and has at least one piercing hole 3131. The collar 314 is disposed between the first end 311 and the second end 312 of the shaft part 31 and is located in the storage space 2113; wherein, the outer diameter of the collar 314 (in an unstressed or undeformed state) is larger than the unstressed or undeformed inner diameter of the first through-hole 2111. The outer diameter of the collar 314 (in an unstressed or undeformed state) is smaller than the unstressed or undeformed inner diameter of the storage space 2113. The collar 314 is axially movable within the storage space 2113, but cannot pass through the first through-hole 2111 to be detached from the housing 21.

The biasing element 32 is sleeved on the second end 312 of the shaft part 31. One end of the biasing element 32 props against the collar 314, the other end props against a bottom wall 2114 of the storage space 2113. Thereby, the biasing element 32 provides an elastic force to cause the collar 314 to prop against and close the first through-hole 2111 (biased into a normally closed position). Wherein, the outer diameter of the biasing element 32 is larger than the inner diameter of the second through-hole 2112, and the outer diameter of the second end 312 of the shaft part 31 is smaller than the inner diameter of the second through-hole 2112.

The anti-reflux element 30 may further include a ring 33. The ring 33 is disposed on a side of the collar 314 adjacent to the first end 311 of the shaft part 31. The outer diameter of the ring 33 is larger than the inner diameter of the first through-hole 2111. The inner diameter of the ring 33 is smaller than the outer diameter of the collar 314. Specifically, the ring 33 is sleeved on the first end 311 of the shaft part 31 and located in the storage space 2113, whereby the ring 33 can be positioned between the collar 314 and the first through-hole 2111. Preferably, the ring 33 is made of elastic plastic, rubber or silica gel, so that the collar 314 has a better leak proof effect when it props against the first through-hole 2111.

FIG. 6 is a using schematic view of the anti-reflux nasogastric tube connected with the extracorporeal tube of the first example of the present invention. As shown in FIG. 6, in the first embodiment of the present invention, when the anti-reflux joint 20 is coupled with the outer pipe joint 51 outside the extracorporeal tube 50, since the outer pipe joint 51 is coupled to the linking part 23, the convex tube 52 of the outer pipe joint 51 will be pressed against the propping part 313, thereby the propping part 313 is pressed and the shaft part 31 is moved axially downward while compressing the biasing element 32. Meanwhile, the liquid food will pass through the piercing hole 3131 of the propping part 313 and flow into the storage space 2113. Since the outer diameter of the second end 312 of the shaft part 31 is smaller than the inner diameter of the second through-hole 2112, the outer wall of the second end 312 of the shaft part 31 will have a gap with the inner wall of the second through-hole 2112 for the passage of liquid food.

FIG. 7 is a schematic view of the anti-reflux nasogastric tube used in the human body of FIG. 3. As shown in FIG. 7, in the first example of the present invention, the tube body 10 is placed in the stomach through the nasal cavity and the esophagus, and the positioning sleeve 60 is stuck in the nostrils of the human body. When the patient wants to be fed, the outer pipe joint 51 is connected to the linking part 23 of the anti-reflux joint 20, so that the liquid food can sequentially pass through the extracorporeal tube 50, the outer pipe joint 51, the first through-hole 2111, the storage space 2113 and the second through-hole 2112 to flow into the tube body 10 to enter the stomach of the human body.

When feeding is completed, it is only necessary to remove the outer pipe joint 51 from the anti-reflux joint 20, meanwhile, since no external force is pressed against the propping part 313, the spring 32 will rebound and the collar 314 cause the rubber ring 33 reseal the first through-hole 2111. Thereby, preventing regurgitation of the food remaining in the tube body 10 and prevention of the nasogastric tube from being contaminated by the environment.

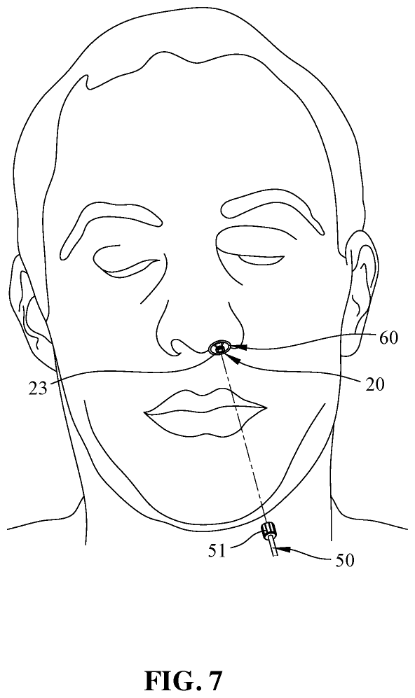

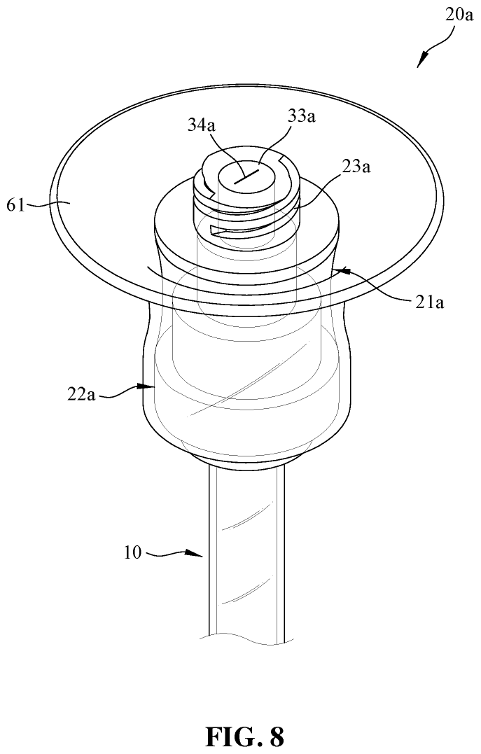

FIG. 8 is a perspective view of the anti-reflux nasogastric tube of the second example of the present invention; FIG. 9A is a front view of the anti-reflux nasogastric tube of the FIG. 8; FIG. 9B is a cross sectional view of the anti-reflux nasogastric tube of FIG. 8. FIG. 9C is a partially exploded cross sectional view of the anti-reflux nasogastric tube of the FIG. 8. As shown in FIGS. 8, and 9A-9C, the difference between the second example and the first example is the structure of a housing 21a and an anti-reflux element 30a included in the anti-reflux joint 20a, and the following is a detailed explanation of each part.

As best seen in FIG. 9B, the housing 21a has a channel 211a. The channel 211a has a first through-hole 2111a, a second through-hole 2112a, and a storage space 2113a. The storage space 2113a is communicated between the first through-hole 2111a and the second through-hole 2112a; The anti-reflux element 30a is disposed in the channel 211a.

Preferably, a first (proximal) end of the housing 21a is provided with a linking part 23a for connecting an outer pipe joint 51 of the extracorporeal tube. The linking part 23a may be a female or male thread for screwing with a female thread of the outer pipe joint 51 of the extracorporeal tube 50. One of ordinary skill in the art should appreciate that any number of quick-connect mechanisms may be used, and that the invention is not limited to the use of threads. For the sake of (non-limiting) example, FIG. 9B depicts linking part 23a as a male thread.

In the second example of the present invention, the housing 21a further includes a bottom housing 22a having a mating portion 222a configured to mate with extending tube 221a. In the drawings the mating portion 222a is depicted as female thread 222a; however, the invention is not limited to a thread (male or female) and any of a variety of connection mechanisms may be used. The extending tube 221a has a second through-hole 2112a. When the tube body 10 is sleeved on the extending tube 221a, the second through-hole 2112a is in fluid communication with the tube body 10. Note that the bottom housing 22a of the present invention has a female thread 222a, and can be further screwed to a kind of tube body (not shown) having a female threaded joint at one end.

In the second example of the present invention, the anti-reflux element 30a is disposed in the channel 211a. The anti-reflux element 30a has a sealing part 31a, a penetrating hole 32a and a blocking part 33a. The sealing part 31a is located in the storage space 2113a. The penetrating hole 32a penetrates through the sealing part 31a. The blocking part 33a is disposed at one end of the sealing part 31a and is located in the first through-hole 2111a. At least one slit 34a is provided at the top of the blocking part 33a.

Preferably, the anti-reflux element 30a is made of elastic material, and may be plastic, rubber or silicone.

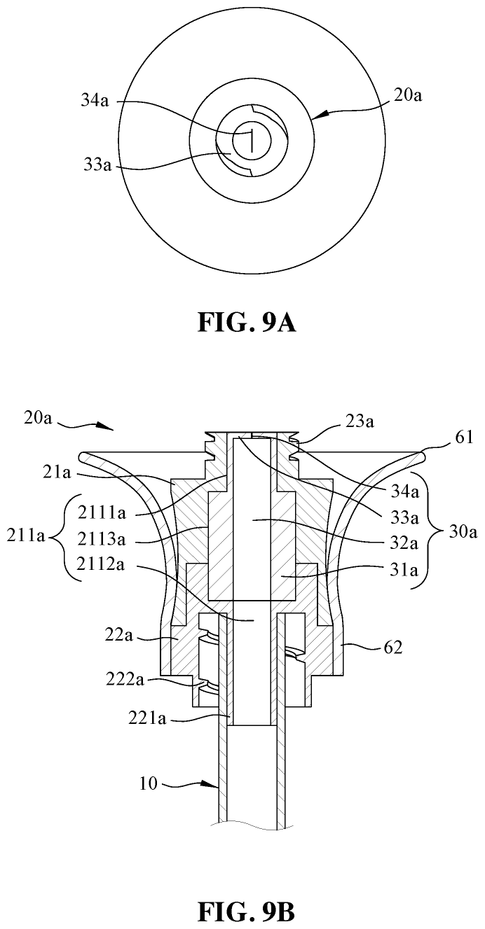

FIG. 10A is a front view of the anti-reflux nasogastric tube connected with the outer pipe joint 51 of the second example of the present invention; FIG. 10B is a cross-sectional view of the anti-reflux nasogastric tube connected with the outer pipe joint 51 of the second example of the present invention.

As shown in FIGS. 10A and 10B, in the second example of the present invention, when one end of the housing 21a is coupled to the outer pipe joint 51 of the extracorporeal tube 50, a convex tube of the outer pipe joint 51 will be pressed against the blocking part 33a, as shown by the dashed line in FIG. 10A. When the outer pipe joint 51 and the linking part 23a are coupled, the convex tube 52 presses against and displaces the blocking part 33a, meanwhile, the slit 34a on the stopper part 33a is opened by the pressing of the convex tube 52.

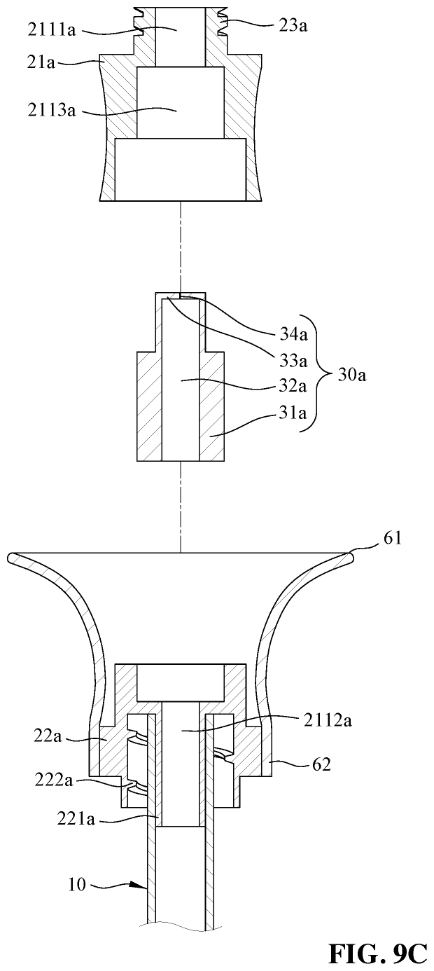

FIG. 11A is a front view of after the anti-reflux nasogastric tube connected with the outer pipe joint 51 of the second example of the present invention. FIG. 11B is a cross-sectional view of after the anti-reflux nasogastric tube connected with the outer pipe joint 51 of the second example of the present invention. As shown in FIG. 11A and FIG. 11B, when the outer pipe joint 51 and the linking part 23a are brought into a coupling relationship (e.g., by screwing or threading), the slit 34a on the blocking part 33a is completely opened by the advancement of the convex tube 52 and the pressing of the blocking part 33a, thereby the extracorporeal tube 50 and the penetrating hole 32a are brought into fluid communication.

In the second example of the present invention, the tube body 10 is placed in the stomach through the nasal cavity and the esophagus, and the positioning sleeve 60 is stuck in the nostrils of the human body. When the patient wants to be fed, the outer pipe joint 51 is first connected to the linking part 23a of the anti-reflux joint 20a, so that the liquid food can sequentially pass through the extracorporeal tube 50, the outer pipe joint 51, the penetrating hole 32a and the second through-hole 2112 to flow into the tube body 10 to enter the stomach of the human body.

When no need to feed, only need to remove the outer pipe joint 51 from the anti-reflux joint 20a, meanwhile, since no external force is pressed against the blocking part 33a, the blocking part 33a deformed by the rotational pressure will rebound to its original biased (closed) state, so that the slit 34a be closed again. Thereby, achieve the effect of prevention of the food remaining in the tube body 10 flowing back (regurgitating) and prevention of the nasogastric tube from being contaminated by the environment.

Note that in the preferred embodiment of the present invention, the linking parts 23, 23a are male threads, however, the linking parts 23, 23a can be modified to be female threads with the same function to be screwed to a male thread of the outer joint 51 of the other kind of extracorporeal tube 50.

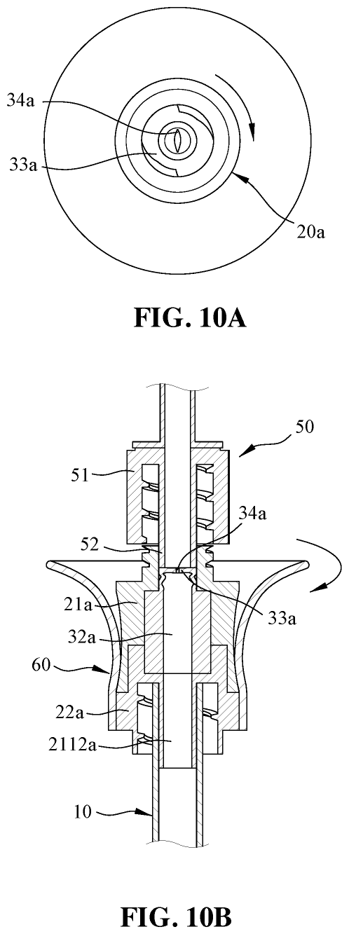

FIG. 12 is a perspective view of the anti-reflux nasogastric tube of the third example of the present invention. As shown in FIG. 12, in the third embodiment of the present invention, the anti-reflux nasogastric tube further includes a pillar plug 40, and the unstressed or unconstrained outer diameter of the pillar plug 40 is greater than the unstressed inner diameter of the positioning sleeve 60, so that the pillar plug 40 can be plugged into the positioning sleeve 60 (interference fit). Thereby, achieve the effect of prevention of the food remaining in the tube body 10 flowing back (regurgitating) and prevention of the nasogastric tube from being contaminated or fouled by the environment. Wherein, in the third example of the present invention, the pillar plug 40 is connected to the positioning sleeve 60, however, the setting manner of the pillar plug 40 is not limited thereto, and may be disposed separately from the positioning sleeve 60.

In summary, the present invention allows the anti-flux joints 20, 20a to be stuck in the nasal cavity of the human body by the positioning sleeve 60, and does not need to be adhered to the cheek of the human body by adhering, thereby reducing the patient's discomfort and increasing the aesthetic appearance and avoiding inadvertent pulling.

Furthermore, by the anti-reflux elements 30, 30a of the anti-reflux joints 20, 20a, the channel 211 of the anti-reflux element 30 or the penetrating hole 32a of the anti-reflux element 30a can be automatically opened when connected to the outer pipe joint 51 to feed, and the channel 211 of the anti-reflux element 20 or the penetrating hole 32a of the anti-reflux element 20a can be automatically closed when separated from the outer pipe joint 51. Thereby, achieve the effect of prevention of the food remaining in the tube body 10 flowing back and prevention of the nasogastric tube from being polluted by the environment.

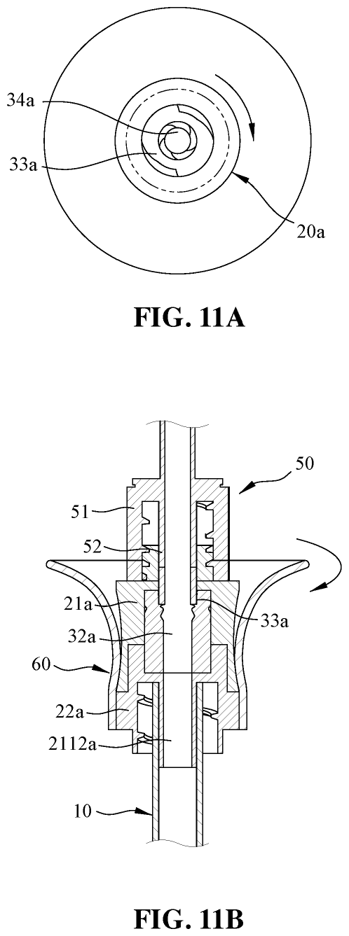

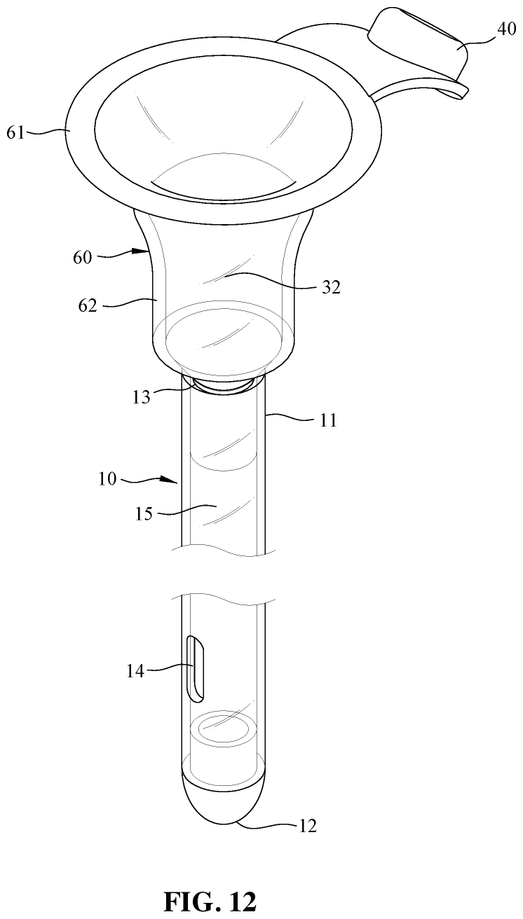

FIGS. 13 and 14 depict a nasogastric tube assembly including gastric feeding tube 131, nutrient tube 132, proximal connector 133 and distal connector 134, respectively. In some examples, proximal connector 133 may be combined with either the distal connector 134. In use, nutrient tube 132 is connected to a source of nutrients or the like to be infused.

The proximal connector 133 has a proximal end 133P and a distal end 133D. Proximal end 133P is configured for attachment to a gastric feeding tube 131. The proximal connector 133 has a lumen 140L extending between the proximal and distal ends 133P, 133D.

The proximal connector 133 includes a nose attachment member 136 attached to an exterior surface of the connector. The proximal connector 133 also includes a normally-closed valve 138 in fluid communication with the proximal connector lumen 138A.

The distal connector 134 has a proximal end 133P and a distal end 134D, and a lumen 140L extending between the proximal and distal ends. The proximal end 134P of the distal connector 134 is removably connected to the distal end 133D of the proximal connector 133 such that the distal connector lumen 140L is in fluid communication with the proximal connector lumen 138a.

The distal connector 134 is provided with a projection 140 on the proximal end thereof which opens the normally-closed valve when the distal connector 134 is engaged with the proximal connector 133.

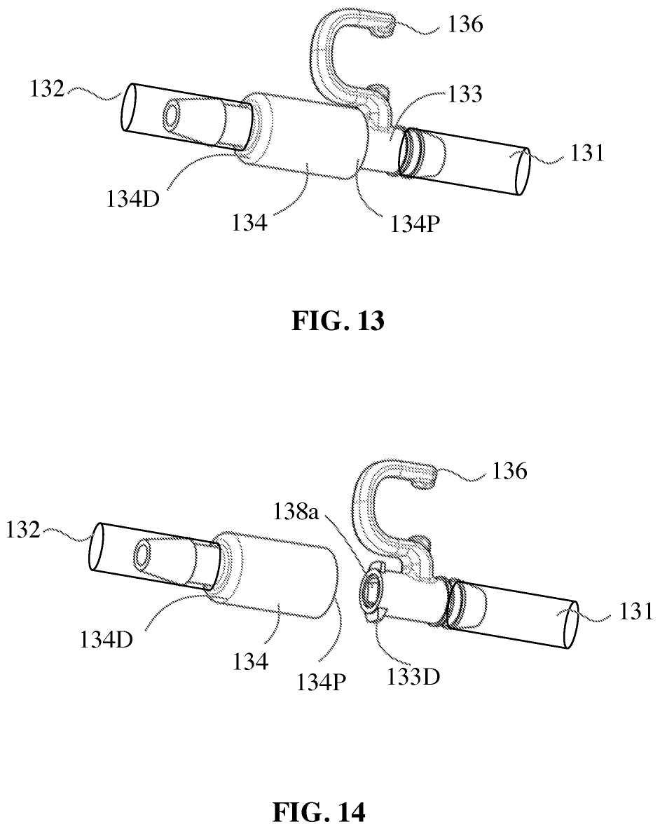

FIG. 15 is an enlarged perspective view of distal connector 134. Distal connector 134 has a first end 134D (distal end) configured for connection to the nutrient tube 132 and second end 134P (proximal end) configured for connection to proximal connector 133. In the example shown in FIG. 15, the protrusion 140 is a cylindrical protrusion having a lumen or fluid channel in fluid communication with lumen 140L.

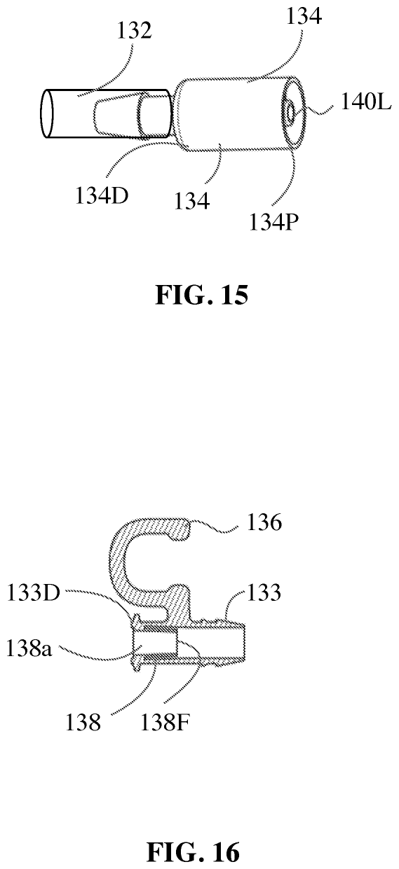

FIG. 16 is a side view of proximal connector 133. Proximal connector 133 has a lumen or fluid channel 138a providing a path for fluid to communicate from tube 131 to the distal connector 134. A normally-closed valve 138 is provided in-line with fluid path of connector 133 such that the valve 138 is closed when proximal connector 133 is disengaged or disconnected from distal connector 134. The normally-closed valve 38 is placed (forced) into an open condition when proximal connector 133 is placed in engagement with distal connector 134 such that the protrusion 140 displaces valve flap 138F. In the Example shown in FIG. 16 the valve 138 includes a flap 138F having a living hinge connected to or integrally formed with an interior wall connector 133.

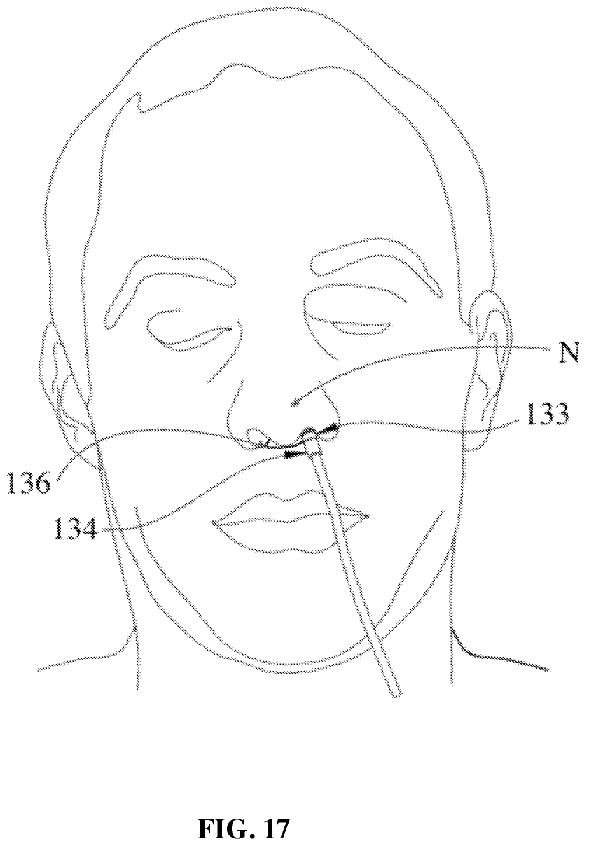

FIG. 17 shows the assembly of FIG. 13 in use. Proximal connector 133 includes a nose attachment portion 136. In the example shown in FIG. 17, nose attachment portion 136 is curved or hooked and is formed of a soft, conformal material, e.g., an elastomeric material, which snugly clips onto the patient's nostril. In some examples, the nose attachment portion 136 is integrally formed or over-molded with proximal connector 133. The nose attachment portion 136 fixes or stabilizes the proximal connector 133, and prevents it from falling into the nasal cavity during use. In some examples, the nose attachment portion 136 and at least a portion of the proximal connector 133 are made of a thermoplastic material. The outer diameter of a proximal end of connector 133 is rounded or beveled and is smaller than the diameter of the human nasal cavity, enabling the proximal end of connector 133 to fit inside the nasal cavity, while the nose attachment portion 136 is placed in engagement with the outer side of the nostril in which the connector 133 is placed.

The normally-closed valve 138 enables the connector 134 to be disconnected from connector 133, while preventing reflux through connector 133. In use, the nose attachment portion 136 and connector 133 remain engaged with patient's nose N regardless of whether distal connector 134 is attached or disengaged from proximal connector 133.

The above description is only for explaining the preferred embodiments of the present invention, and is not intended to be any form of limitation of the present invention. Therefore, any modifications or variations of the present invention made in the spirit of the invention should be included in the scope of the invention as claimed.

What is claimed is:

1. An anti-reflux nasogastric tube sized for insertion into a nostril of the human body, comprising:
a tube body having a sidewall and a lumen extending between a proximal end and a distal end thereof, the proximal end having an opening, at least one through-hole defined in the sidewall proximal the distal end, the opening is in fluid communication with the at least one through-hole; and
a positioning sleeve mounted to the tube body and in fluid communication with the opening, the positioning sleeve having a socket part and an outer edge, the outer edge located at one end of the socket part, the outer edge having a diameter selected to be larger than an inner diameter of the nostril of the human body.

2. The anti-reflux nasogastric tube of claim 1, further comprising an anti-reflux joint disposed on a first end of the tube body and located in the socket part, the anti-reflux joint comprising a housing and an anti-reflux element, the housing having a channel, and one end of the housing is provided with a linking part for connecting an extracorporeal tube, the anti-reflux element is disposed in communication with the channel.

3. The anti-reflux nasogastric tube of claim 2, wherein the channel has a first through-hole, a second through-hole and a storage space interposed therebetween, the storage space is in communication between the first through-hole and the second through-hole for communicating with the extracorporeal tube.

4. The anti-reflux nasogastric tube of claim 3, wherein the anti-reflux element comprises a shaft part and a biasing element, the shaft part has a first end, a second end, a propping part and a collar, the first end of the shaft part extends in the first through-hole, the propping part is disposed on the first end of the shaft part and has at least one piercing hole, the collar is disposed between the first end and the second end of the shaft part and located in the storage space, the outer diameter of the convex ring in an unstressed state is larger than the inner diameter of the first through-hole in an unstressed state, the outer diameter of the convex ring in an unstressed state is smaller than the inner diameter of the storage space, the biasing element is sleeved on the second end of the shaft part, one end of the biasing element abuts the collar, the other end abuts a bottom wall of the storage space.

5. The anti-reflux nasogastric tube of claim 4, wherein the anti-reflux element further comprises a sealing ring, the sealing ring is disposed on a side of the convex ring adjacent to the first end of the shaft portion, the outer diameter of the sealing ring in an unstressed state is larger than the inner diameter of the first through-hole, and the inner diameter of the sealing ring in an unstressed state is smaller than the outer diameter of the collar ring in an unstressed state.

6. The anti-reflux nasogastric tube of claim 4, wherein the outer diameter of the biasing element is larger than the inner diameter of the second through-hole.

7. The anti-reflux nasogastric tube of claim 3, wherein the anti-reflux element has a sealing part, a penetrating hole and a blocking part, the sealing part is located in the storage space, the penetrating hole penetrates through the sealing part, the blocking part is disposed at one end of the sealing part and located in the first through-hole, at least one slit is provided at the top of the blocking part.

8. The anti-reflux nasogastric tube of claim 7, wherein the housing further comprises a bottom housing having a threaded portion and an extending tube, the extending tube has a second through-hole.

9. The anti-reflux nasogastric tube of claim 2, wherein the housing further comprises a positioning part, the positioning part is convexly disposed at a middle portion of the housing, the outer diameter of the positioning part in an unstressed state is larger than the inner diameter of the sleeve part in an unstressed state, so that the socket part is expanded outwardly by the positioning part to be positioned on the housing.

10. The anti-reflux nasogastric tube of claim 1, further comprising a pillar plug, the outer diameter of the plug in an unstressed state is greater than the inner diameter of the positioning sleeve in an unstressed state.

11. The anti-reflux nasogastric tube of claim 2, wherein the anti-reflux joint is a normally-closed valve.

12. The anti-reflux nasogastric tube of claim 1, wherein the positioning sleeve has a proximal end and a distal end, a diameter of the distal end is selected to be smaller than the inner diameter of the nostril such that the distal end is received within the nostril.

13. A nasogastric tube assembly, comprising:
a proximal connector having a proximal end and a distal end, the proximal end configured for attachment to a feeding tube, the connector having a lumen extending between the proximal and distal ends;
a nose attachment member attached to an exterior surface of the connector; and
a normally-closed valve in fluid communication with the proximal connector lumen.

14. The nasogastric tube assembly of claim 1, further comprising:
a distal connector having a proximal end and a distal end;
a lumen extending between the proximal and distal ends;
the distal connector proximal end removably connected to the distal end of the proximal connector such that the distal connector lumen is in fluid communication with the proximal connector lumen; and
a projection on the proximal end of the distal connector;
wherein the projection opens the normally-closed valve when the distal connector is engaged with the proximal connector.

15. The nasogastric tube assembly of claim 1, wherein the nose attachment member is formed of an elastomeric material.

16. The nasogastric tube assembly of claim 2, wherein the distal end of the distal connector includes a mounting portion configured for attachment to a tube.

17. The nasogastric tube assembly of claim 2, wherein the projection is a tubular projection in fluid connection with the distal connector lumen.
